(19) United States
(12) Patent Application Publication
(10) Pub. No.: US 2021/0091464 A1
(43) Pub. Date: Mar. 25, 2021

(54) EVOLVED DISTRIBUTED ANTENNA SYSTEM

(71) Applicant: SOLiD, INC., Seongnam-si (KR)

(72) Inventors: Dong Hee KWON, Yongin-si (KR); Yong Hoon KANG, Seoul (KR)

(73) Assignee: SOLiD, INC., Seongnam-si (KR)

(21) Appl. No.: 16/671,166

(22) Filed: Oct. 31, 2019

(30) Foreign Application Priority Data
Oct. 31, 2018 (KR) 10-2018-0132391
Oct. 31, 2018 (KR) 10-2018-0132392
Oct. 31, 2018 (KR) 10-2018-0132394
Oct. 31, 2019 (KR) 10-2019-0138172

(51) Int. Cl. H01Q 3/38; H04B 7/024; H04W 72/04

(52) U.S. Cl. CPC H01Q 3/38; H04W 72/0413; H04B 7/024

(57) ABSTRACT

According to an aspect of the inventive concept of the disclosure, an evolved radio access network comprises: a plurality of signal sources supporting any one of heterogeneous mobile communication technology standards and data services, a hub connected to a plurality of signal sources, and a plurality of remote units connected through a hub and a transmission network.

### CROSS-REFERENCE TO RELATED APPLICATION

This application claims the benefit of Korean Patent Applications No. 10-2018-0132391, 10-2018-0132392, and 10-2018-0132394 filed on Oct. 31, 2018 and Korean Patent Application No. 10-2019-0138172 filed on Oct. 31, 2019 in the Korean Intellectual Property Office, the disclosures of which are incorporated herein in its entirety by reference.

### BACKGROUND

### 1. Field

The disclosure relates to a distributed antenna system, and more particularly, evolved distributed antenna system suitable for next-generation radio networks.

### 2. Description of the Related Art

A distributed antenna system (DAS) is a system composed of spatially separated antenna nodes connected to a common node through a transmission medium such as optical fiber, wired Ethernet, or a transmission network. The DAS expands coverage of a base station by providing mobile communication services to the shaded areas where signals from the base station is difficult to reach because it is installed in areas where radio signals are not received or where the radio signals are not received, such as inside buildings, underground buildings, subways, tunnels, apartment complexes in residential areas, stadiums, etc.

With the advent of 5G technology, technologies required for radio access networks such as distributed antenna systems are becoming more diverse. In addition to the increasing number of types, the network structure according to the characteristics of each technology is also evolving differently. In particular, the elements constituting the network and the types of network configurations and types of signals connecting the elements are diversified according to technology, and it is difficult to integrate them into one system or network.

In addition, considering such a trend toward the next generation 5G/wireless network, it is impossible to accommodate new technologies with a typical DAS optimized for 4G, and thus, development of a DAS for the next generation/5G wireless network is required.

In addition, the DAS has a limitation in providing positioning services required by service providers in accordance with E911 requirements due to the spatial characteristics in which the DAS is installed. A network-based positioning services based on base station Cell/Sector ID, AoA (Angle of Arrival), TDoA (Time Difference of Arrival), or GPS-based positioning services based on base station cell-ID and GPS infrastructure are practically impossible to implement due to the nature of the DAS installed in the room, and its accuracy is significantly lowered, so they cannot meet the FCC requirements. In addition, WiFi-based positioning services are economically disadvantageous and inaccurate as the DAS requires additional devices and functions. Therefore, there is a need for a method capable of providing a high-accuracy positioning service at low cost using the DAS.

### SUMMARY

Provided are the evolved radio access network according to the inventive concept of the disclosure capable of supporting the next generation 5G mobile communication technology, 3G and 4G mobile communication technologies as well as accommodating heterogeneous data services such as WiFi and IoT.

Provided is the DAS for the next generation/5G radio access network according to the inventive concept of the disclosure capable of conforming to the evolved fronthaul structure and accommodating new technologies of the next generation/5G wireless network.

Provided is the method of determining a location of a user equipment using the DAS according to the inventive concept of the disclosure capable of enabling positioning of the user equipment with low cost and high accuracy.

According to an aspect of the inventive concept of the disclosure, an evolved radio access network comprises: a plurality of signal sources supporting any one of heterogeneous mobile communication technology standards and data services; a hub connected to a plurality of signal sources; and a plurality of remote units connected through a hub and a transmission network.

According to an aspect of the inventive concept of the disclosure, a DAS for a next generation wireless network comprises: a virtualized digital unit pool; and a plurality of remotes communicatively connected to the virtualized digital unit pool through a transmission network, and having a low-PHY function.

According to an aspect of the inventive concept of the disclosure, a method for determining a location of a user equipment using a DAS comprises: extracting an RNTI by analyzing an uplink signal received from the user equipment; and estimating the location of the corresponding user equipment from a preset user equipment location map based on the extracted RNTI.

An evolved radio access network according to embodiments of the inventive concept of the disclosure may support the next generation 5G mobile communication technology as well as 3G, 4G mobile communication technology through a single network, accommodate heterogeneous data services such as WiFi and IoT to integrate cost-effectively, and enable interworking between heterogeneous networks.

In addition, the evolved radio access network according to embodiments of the inventive concept of the disclosure may dynamically control heterogeneous technology and process heterogeneous services based on software-defined radio to meet the needs of operators or networks.

In addition, the evolved radio access network according to embodiments of the inventive concept of the disclosure may serve as a platform for an in-building communication system when implemented in a building.

The distributed antenna system for the next generation/5G radio network according to embodiments of the inventive concept of the disclosure may conform to the evolved fronthaul structure and enable the next generation 5G radio network technologies to be accommodated.

The method of determining a location of a user equipment using DAS according to embodiments of the inventive concept of the disclosure may enable positioning of the user equipment with low cost and high accuracy.

The effect obtained by the embodiments according to the inventive concept of the disclosure is not limited to the effect (s) mentioned above, and the other effect (s) not mentioned may be clearly understood by one of ordinary skilled in the art from descriptions below.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram schematically showing an evolved radio access network according to the inventive concept of the present disclosure;

FIG. 2 is a diagram for explaining a modification of the radio access network of FIG. 1;

FIG. 3 is a diagram for explaining various implementations of a remote unit constituting the radio access network of FIG. 1;

FIG. 4 is a diagram for explaining another implementation of the remote unit constituting the radio access network of FIG. 1;

FIG. 5 is a diagram schematically showing a DAS for a next generation radio network according to the inventive concept of the present disclosure;

FIGS. 6 to 10 are diagrams for explaining various applications of the DAS for the next generation radio network according to the inventive concept of the present disclosure;

FIG. 11 is a diagram for explaining an environment in which a method of determining a location of user equipment using DAS according to the inventive concept of the present disclosure;

FIG. 12 is a diagram for explaining an application example of the method for determining a location of user equipment using DAS according to the inventive concept of the present disclosure.

### DETAILED DESCRIPTION

The disclosure may be variously modified and have various embodiments, so that specific embodiments will be illustrated in the drawings and described in the detailed description. However, this does not limit the disclosure to specific embodiments, and it should be understood that the disclosure covers all the modifications, equivalents and replacements included within the idea and technical scope of the disclosure.

In the following description, a detailed explanation of known related technologies may be omitted to avoid unnecessarily obscuring the subject matter of the present disclosure. In addition, numeral figures (e.g., first, second, and the like) used during describing the specification are just identification symbols for distinguishing one element from another element.

Further, in the specification, if it is described that one component is “connected” or “accesses” the other component, it is understood that the one component may be directly connected to or may directly access the other component but unless explicitly described to the contrary, another component may be “connected” or “access” between the components.

In addition, terms including “unit”, “er”, “or”, “module”, and the like disclosed in the specification mean a unit that processes at least one function or operation and this may be implemented by hardware such as a processor, a micro processor, a micro controller, a central processing unit (CPU), a graphics processing unit (GPU), an accelerated Processing unit (APU), a digital signal processor (DSP), an application specific integrated circuit (ASIC), and a field programmable gate array (FPGA), or software, or a combination of hardware and software.

Moreover, it is intended to clarify that components in the specification are distinguished in terms of primary functions of the components. That is, two or more components to be described below may be provided to be combined to one component or one component may be provided to be divided into two or more components for each more subdivided function. In addition, each of the respective components to be described below may additionally perform some or all functions among functions which other components take charge of in addition to a primary function which each component takes charge of and some functions among the primary functions which the respective components take charge of are exclusively charged by other components to be performed, of course.

Hereinafter, various embodiments of the disclosure will be described in detail in order.

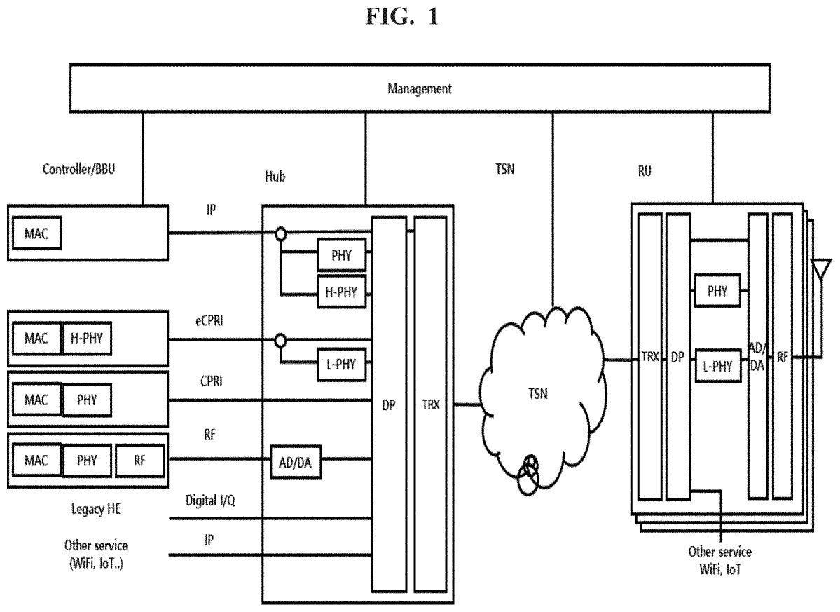

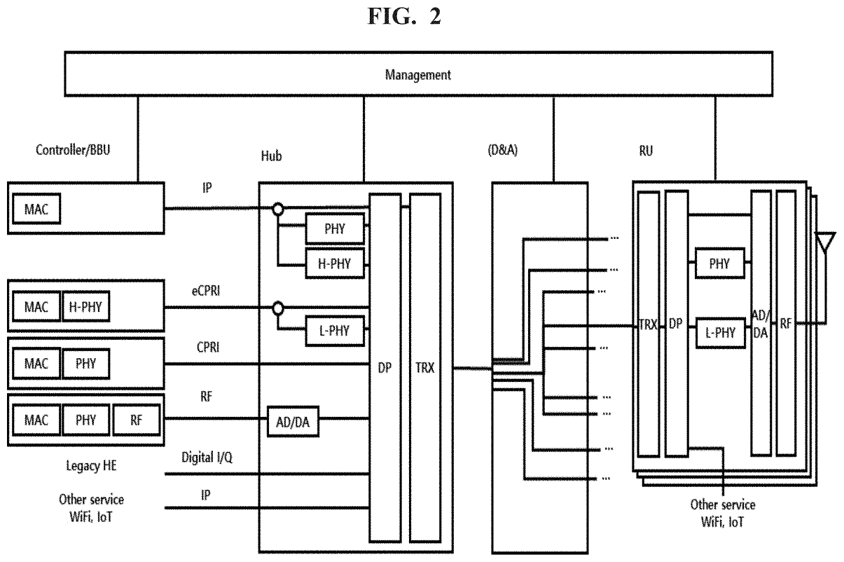

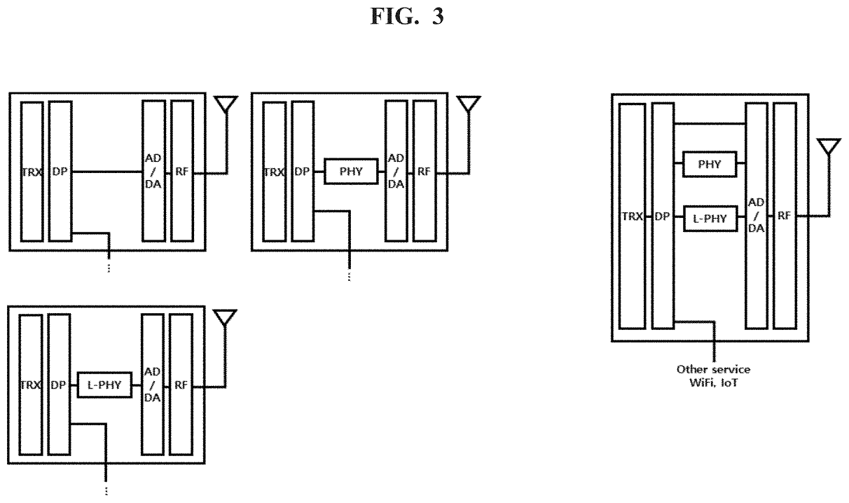

FIG. 1 is a diagram schematically showing an evolved radio access network according to the inventive concept of the present disclosure, FIG. 2 is a diagram for explaining a modification of the radio access network of FIG. 1, and FIG. 3 is a diagram for explaining various implementations of a remote unit constituting the radio access network of FIG. 1.

First, referring to FIG. 1, the evolved radio access network may include a plurality of signal sources (Controller/BBU, Legacy HE, Other Service (WiFi, IoT)), at least one hub, and a transmission network (TSN), a plurality of remote units (RUs), a Management.

The signal source may be a base station supporting 3G to 5G mobile communication technology standards. For example, the signal source supports a 5G mobile communication technology standard, and some functions may be a hub or a base station separated by a remote unit. That is, the signal source is a controller/BBU corresponding to a base station, and may be a base station having at least one of a MAC function and a high-PHY function.

Or, the signal source may be a base station supporting 3G and 4G mobile communication technology standards. More specifically, the signal source may be a base station having at least one RF function or more from a MAC function.

Or, the signal source may be the headend of a typical legacy DAS.

Or, the signal source may be a base station, core, network, etc. supporting data services such as WiFi and IoT.

The hub may be communicatively connected to various types of signal sources through respective corresponding interfaces. For example, when the signal source is a 5G base station having only a MAC function, the Hub can be connected to the corresponding base station through an IP interface. Or, when the signal source is a 5G base station having a MAC function and a High-PHY function, the Hub may be connected to the corresponding base station through an eCPRI interface. Or, if the signal source is a 4G base station having a MAC function and a PHY function, the Hub may be connected to the corresponding base station through a CPRI interface. Or, when the signal source is a 3G base station having a MAC function, a PHY function, and an RF function, the Hub may be connected to the corresponding base station through an RF interface. Or, when the signal source is the headend of the digital legacy DAS, the Hub may receive I/Q data from the headend of the legacy DAS. Or, when the signal source is the headend of the analog legacy DAS, the Hub can receive an RF signal from the headend of the legacy DAS. Or, if the signal source is a base station that supports data services such as WiFi and IoT, the Hub may be connected to the corresponding base station through an IP interface.

The Hub digitally processes signals received from various signal sources, such as aggregates, and distributes the processed signals to a plurality of RUs through a transmission network, such as a time-sensitive network. In this case, the Hub can be adjusted so that latency or jitter of each signal path does not become a problem even in the case of dynamic configuration under management control.

Meanwhile, as illustrated in FIG. 2, the transmission network may be replaced with a Distributor & Aggregator (D & A) that duplicates a signal received from the Hub and transmits it to a plurality of remote units. Also, this D & A can be implemented by being included in the Hub's Digital Processing and TRX blocks.

Referring back to FIG. 1, RUs may have only a RF function according to a signal input from a signal source to a hub, or have various functions such as a low-PHY function and a PHY function.

Management can manage the entire network, including signal sources.

In order to make the network configuration flexible under the control of the management, the Hub may automatically recognize the type of the input signal and optimally set the location to process the following steps accordingly. For example, a MAC-PHY interface signal may be received to pass PHY processing, or High-PHY processing, or pass as it is. For the High-PHY signal, it can be processed through Low-PHY or just pass.

In the configuration of the signal source-Hub-RU, which is a controller (MAC), the PHY function is placed on the RU and the RU is configured as an independent cell or the function of bundling between RUs as a sub-cell is implemented to minimize interference between different regions, or configure a single independent cell by connecting the RUs with the MIMO split function with the PHY function in the hub.

In the configuration of the signal source-Hub-RU, which is a controller (MAC, High-PHY), MIMO layer split can be implemented with the L-PHY in the Hub, or the configuration change that increases the capacity through MIMO service by lowering the L-PHY to RU is also possible.

By dynamically adjusting these, the performance in the network can be optimized. Such adjustment may be performed based on the analysis results of many and few users in the network, movement between cells, and communication traffic in the network.

In particular, the PHY layer processing function of the Hub and the RU may be dynamically set. For example, the Hub and the RU can process all or part of the PHY layer, and can dynamically set the PHY layer processing function.

When the network changes to a new generation technology, the location of the PHY layer may be moved from the Hub to the RU to implement the necessary functions. For example, in the case of 5G, in order to support beam forming, the transmission capacity to the RU is too large, so the PHY may need to be located in the RU. In this case, the PHY layer processing function of the Hub and the RU may be reset.

In addition, when the transmission network shares with other service signals (WiFi wired internet data), even if the transmission signal of the main network needs to be reduced or increased according to the transmission capacity of other services, the PHY layer processing function may be reset to respond.

In addition, when the number of carriers to be supported exceeds the processing capacity of the RU, the configuration may be changed in order to perform some PHY processing in the hub, that is, the layer processing function in the hub and the RU may be changed.

Referring to FIG. 3, the RUs may have different RUs having different signal units to be processed according to types (left diagram, fixed RU), and RUs having all signal processing parts that can be variously processed according to input signals (right diagram, SDR RU). In the case of the fixed RU, it may be an existing legacy RU. In the case of the SDR RU, it is possible to detect a type of an input signal and automatically connect a signal processing unit suitable for it, and may have a function of automatically setting a signal processing unit according to the type of the input signal. However, the inventive concept is not limited thereto, and the automatic setting function may be performed by management control.

In addition, the RU may have spare HW slots to secure HW resources for processing new functions.

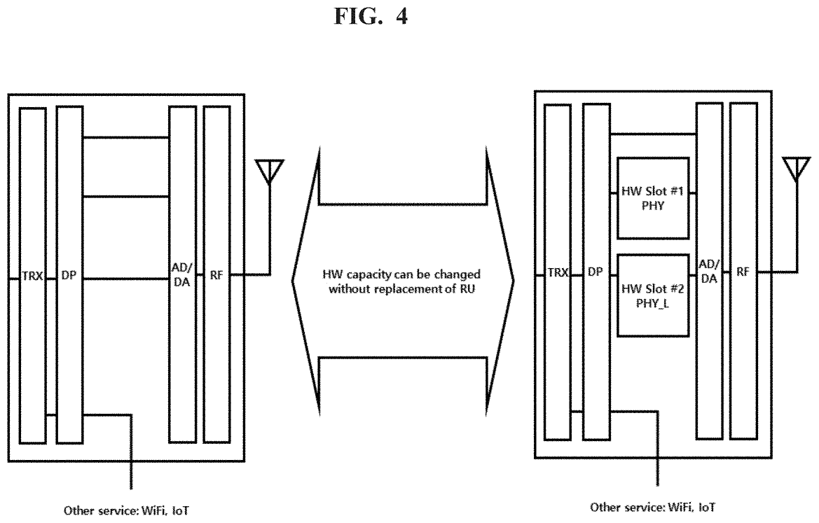

Referring to FIG. 4 further, the RU may have HW resources for dynamic reconfiguration from the beginning, but there may be an uncertainty that the initial burden may be large and how much HW capacity will be needed in the future.

Accordingly, only the minimum digital part for CPRI (Function Split Option 8) is placed in the RU, and the rest is processed as slots. HW Sub-board type may be added and used when additional resources are needed such as PHY layer processing or a process to support additional carriers.

Conversely, if the processing capacity is reduced according to reconfiguration, efficiency can be increased by removing the HW sub-board that is no longer needed and recycling it elsewhere.

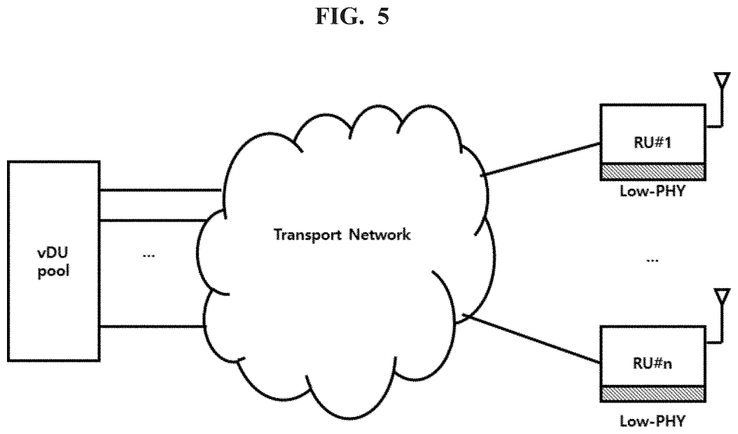

FIG. 5 is a diagram schematically showing a DAS for a next generation radio network according to the inventive concept of the present disclosure.

Referring to FIG. 5, the DAS for the next generation wireless network a headend, which is an interfaces with a base station side and a common node connected to spatially separated antenna nodes, may be omitted, and a virtualized digital unit pool (vDU pool) and a plurality of remote units (RUs) as antenna node may have a structure that is directly connected through a transport network. Here, the transmission network may include at least one or more routing nodes, and the transmission network may support various interfaces such as Ethernet, eCPRI, and Radio over Ethernet (RoE).

At least one of the plurality of RUs may include a Low-PHY function among the functions of the base station, and this RU is substantially the same as a remote radio head (RRH).

However, the inventive concept is not limited thereto, and at least one of the plurality of RUs may further include not only a low-PHY, but also a higher function, such as a low-MAC, a high-PHY, and the existing legacy RU and Likewise, it may include only the RF function.

This function separation or function aggregation may be performed by vDU.

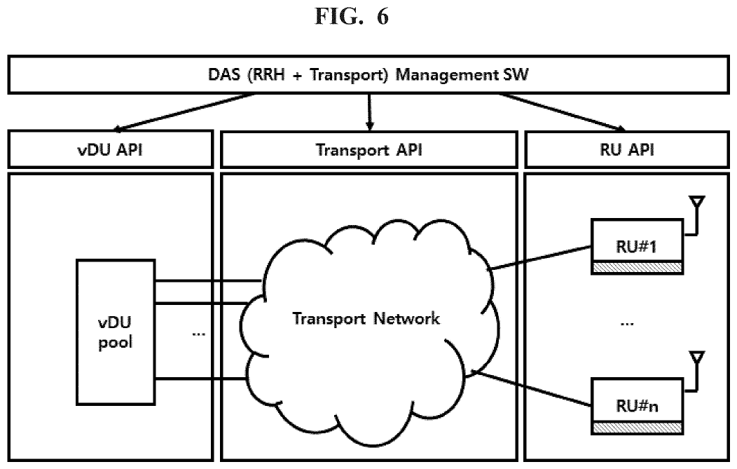

FIGS. 6 to 10 are diagrams for explaining various applications of the DAS for the next generation radio network according to the inventive concept of the present disclosure.

Referring to FIG. 6, a DAS for a next-generation wireless network according to an embodiment, may not replicate signals in a typical DAS, for example, multicasts the same downlink signals to at least two or more RUs in a common node headend. It may be possible to unicast downlink and uplink signals between a vDU pool and multiple RUs. At this time, the delivery path of downlink and uplink signals in the transmission network can be actively and real-time controlled by the DAS management software.

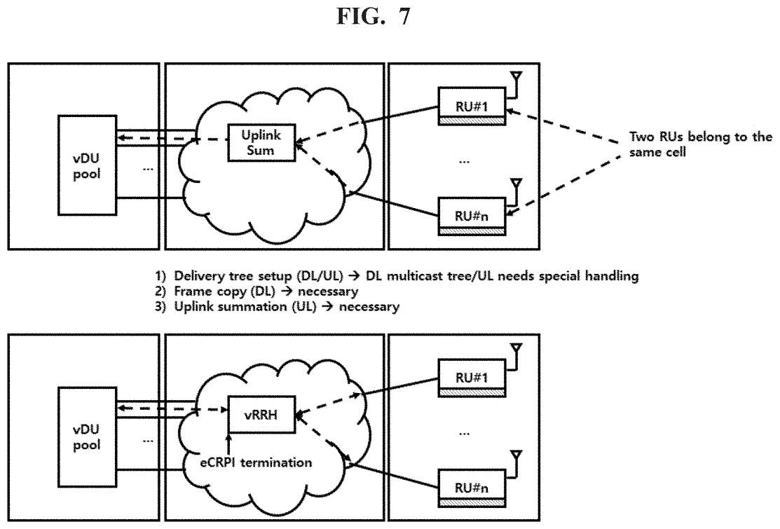

Referring to FIG. 7, a DAS for a next-generation wireless network according to an embodiment may multicast downlink signals to a vDU pool and a plurality of RUs as in a typical DAS, and uplink signals transmitted from a plurality of RUs to the vDU pool can be summed.

To this end, at least one of the routing nodes constituting the transmission network may include an uplink summation function, and the corresponding routing node and RUs connected thereto operate as a single virtualized RRH.

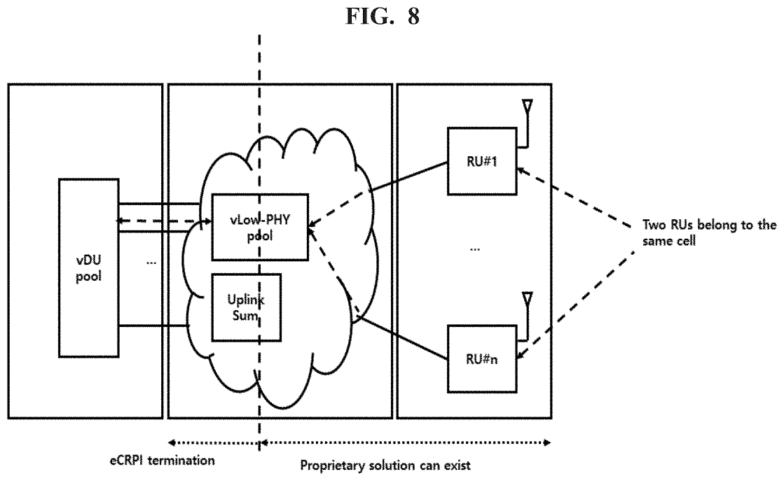

Referring to FIG. 8, in the DAS for the next generation wireless network according to an embodiment, at least one of the routing nodes constituting the transmission network has a Low-PHY function, and RUs connected to the routing node are legacy RUs. At this time, an interface such as Ethernet and eCPRI may be supported between the vDU pool and the corresponding routing node, and the routing node and legacy RUs may support Ethernet, eCPRI, etc. as well as legacy interfaces (eg, analog, digital, CPRI, etc.).

Meanwhile, the corresponding routing node may be implemented independently or integrally with the uplink summing function described above.

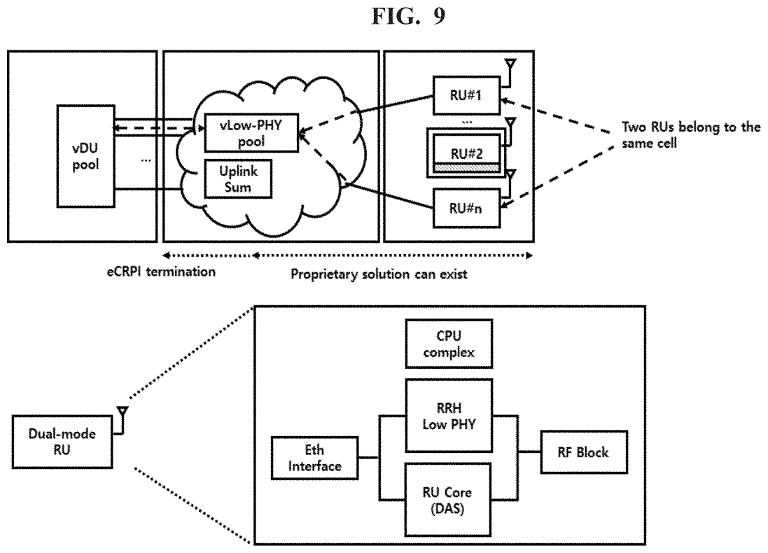

Referring to FIG. 9, in the DAS for a next generation wireless network according to an embodiment, as described with reference to FIG. 4, one of some routing nodes has a Low-PHY function and RUs connected to the routing node are legacy Consisting of RUs, other RUs may have a mixed structure having a Low-PHY function as described with reference to FIGS. 5 and 6. At this time, the RU having a low-PHY function may be implemented as a RU in a dual mode having the same function as a legacy RU.

When an RU having a Low-PHY function is connected to a routing node having a Low-PHY function, the routing node may transmit a downlink signal to a RU having a Low-PHY function without processing the Low-PHY.

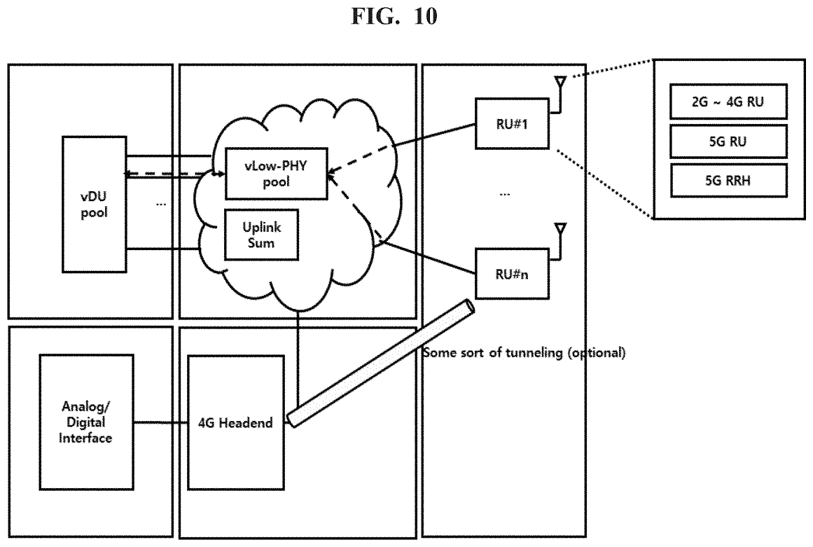

Referring to FIG. 10, a DAS for a next-generation wireless network according to an embodiment may be linked with a legacy DAS supporting 2G to 4G services. That is, the headend of the legacy DAS may be communicatively connected to the RU through the transmission network, and in this case, the RU may be configured to operate in any one of RU, RRH, and legacy RU modes for 5G.

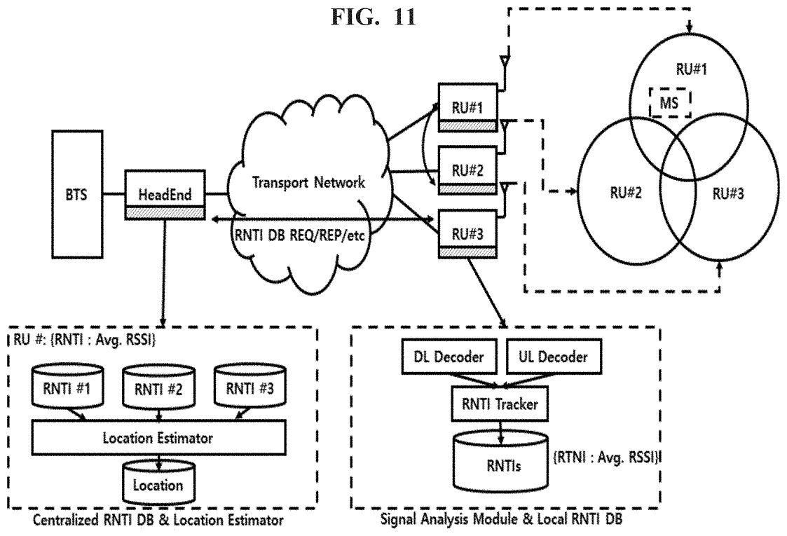

FIG. 11 is a diagram for explaining an environment in which a method of determining a location of user equipment using DAS according to the inventive concept of the present disclosure.

DAS according to an embodiment will be described with reference to FIG. 11. The DAS includes a plurality of RUs RU #1 to RU #3, each of which is remotely connected to the headend through at least one headend and a transport network communicatively connected to a base station (BTS).

Further, the headend may include a centralized RNTI DB (Centralized RNTI Database) and a location estimator, and each RU may include a signal analysis module and a local RNTI DB (Local RNTI Database).

First, the signal analysis module and the local RNTI DB may analyze the uplink signal received from user equipment (UE) located in the service coverage of the corresponding RU to measure RSSI and extract the Radio Network Temporary Identifier (RNTI). The signal analysis module and the local RNTI DB may store the RNTI of the UE located in the service coverage of the corresponding RU based on the measured RSSI, and transmit the RSSI-RNTI information of the stored UE to the headend. Here, RNTI is an ID assigned to a connected mode user equipment and refers to a temporary ID used in a cell.

And, the centralized RNTI DB and the location estimator can receive the RSSI-RNTI of UEs received from the signal analysis module and the local RNTI DB of each RU, and may configure and store the UE location map within service coverage of each RU based on the RSSI-RNTI of the UEs.

The method for determining the location of user equipment using the DAS will be described in more detail.

When a UE located in the service coverage of any one of a plurality of RUs requests a call, the signal analysis module of the corresponding RU and the local RNTI DB analyze the received uplink signal, measure RSSI, and extract RNTI.

When the RU determines that the RSSI measurement result for the UE is located within its coverage, the RU transmits the RSSI measurement result and the extracted RNTI to the Headend through the transport network. In another embodiment, the RU may transmit the extracted RNTI to the headend through the transport network without considering the RSSI measurement result.

The centralized RNTI DB and location estimator of the headend may estimate the location of the corresponding UE by querying the previously stored UE location map for each RU based on the received RSSI-RNTI.

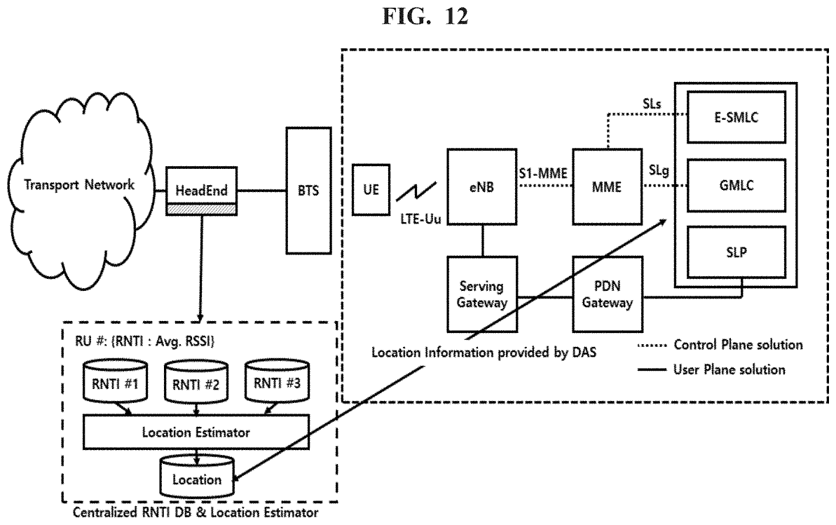

FIG. 12 is a diagram for explaining an application example of the method for determining a location of user equipment using DAS according to the inventive concept of the present disclosure.

Referring to FIG. 12, the centralized RNTI DB and location estimator of the headend may be communicatively connected or interlocked with the base station, and transmit the location estimation result and RNTI for a specific UE to the base station.

The base station may identify the user of the UE by mapping the received location estimation result and RNTI with the pre-stored TMSI information. Here, TMSI (Temporary Mobile Subscriber Identity) is a user-specific ID managed by the base station.

On the other hand, although not shown in FIG. 12, the Headend may be directly connected or interlocked with the E911 server. Accordingly, the E911 server can appropriately respond to an emergency by identifying a user of the UE based on the location estimation result of the UE of the headend and the RNTI.

Hereinabove, the disclosure has been described with reference to the preferred embodiments. However, it will be appreciated by those skilled in the art that various modifications and changes of the disclosure can be made without departing from the scope of the disclosure which are defined in the appended claims and their equivalents.

What is claimed is:

1. An evolved radio access network comprising:
a plurality of signal sources supporting any one of heterogeneous mobile communication technology standards and data services;
a hub connected to a plurality of signal sources; and
a plurality of remote units connected through a hub and a transmission network.

2. A distributed antenna system (DAS) for a next generation wireless network, the DAS comprising:
a virtualized digital unit pool; and
a plurality of remotes communicatively connected to the virtualized digital unit pool through a transmission network, and having a low-PHY function.

3. A method for determining a location of a user equipment using a DAS, the method comprising:
extracting an RNTI by analyzing an uplink signal received from the user equipment; and
estimating the location of the corresponding user equipment from a preset user equipment location map based on the extracted RNTI.
